(19) United States
(12) Patent Application Publication
(10) Pub. No.: US 2018/0297756 A1
(43) Pub. Date: Oct. 18, 2018

(54) Secured Container

(71) Applicants: Luz Vidal, Yonkers, NY (US); Ishmael Montanez, Yonkers, NY (US)

(72) Inventors: Luz Vidal, Yonkers, NY (US); Ishmael Montanez, Yonkers, NY (US)

(21) Appl. No.: 15/485,795

(22) Filed: Apr. 12, 2017

(51) Int. Cl. B65D 55/14; B65D 51/24; B65D 6/00; B65D 43/22; B65D 43/16; B65D 47/32; B65D 25/28; E05B 49/00; G07C 9/00

(52) U.S. Cl. CPC B65D 55/145; B65D 51/245; B65D 11/10; B65D 43/22; B65D 2525/283; B65D 47/32; B65D 25/2802; E05B 49/00; G07C 9/00039; B65D 43/163

(57) ABSTRACT

A secured container for securely storing a user's food items includes a shell that defines an internal space. The shell has a top that is open. A lid is hingedly coupled to the shell. The lid is lockably couplable to the shell to secure items, such as food, that are positioned in the internal space. A plurality of slits that is positioned through the lid is configured to vent the internal space. A pair of panels is coupled to the front of the shell to define a pair of slots. The panels are substantially transparent. The slots are configured to insert labels, such as a label that has a name of a user and a label that dates the items.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

[symbol]

### (2) Description of Related Art Including Information Disclosed under 37 CFR 1.97 and 1.98.

The disclosure and prior art relates to containers and more particularly pertains to a new container for securely storing a user's food items.

### BRIEF SUMMARY OF THE INVENTION

An embodiment of the disclosure meets the needs presented above by generally comprising a shell that defines an internal space. The shell has a top that is open. A lid is hingedly coupled to the shell. The lid is lockably couplable to the shell to secure items, such as food, that are positioned in the internal space. A plurality of slits that is positioned through the lid is configured to vent the internal space. A pair of panels is coupled to the front of the shell to define a pair of slots. The panels are substantially transparent. The slots are configured to insert labels, such as a label that has a name of a user and a label that dates the items.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a secured container according to an embodiment of the disclosure.

FIG. 2 is a side view of an embodiment of the disclosure.

FIG. 3 is a top view of an embodiment of the disclosure.

FIG. 4 is a front view of an embodiment of the disclosure.

FIG. 5 is a cross-sectional view of an embodiment of the disclosure.

### DETAILED DESCRIPTION OF THE INVENTION

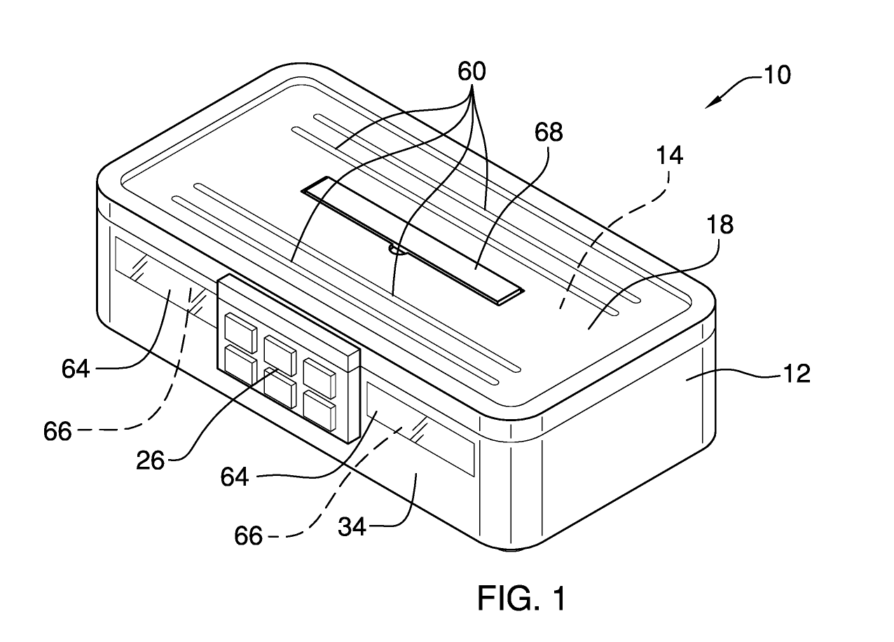

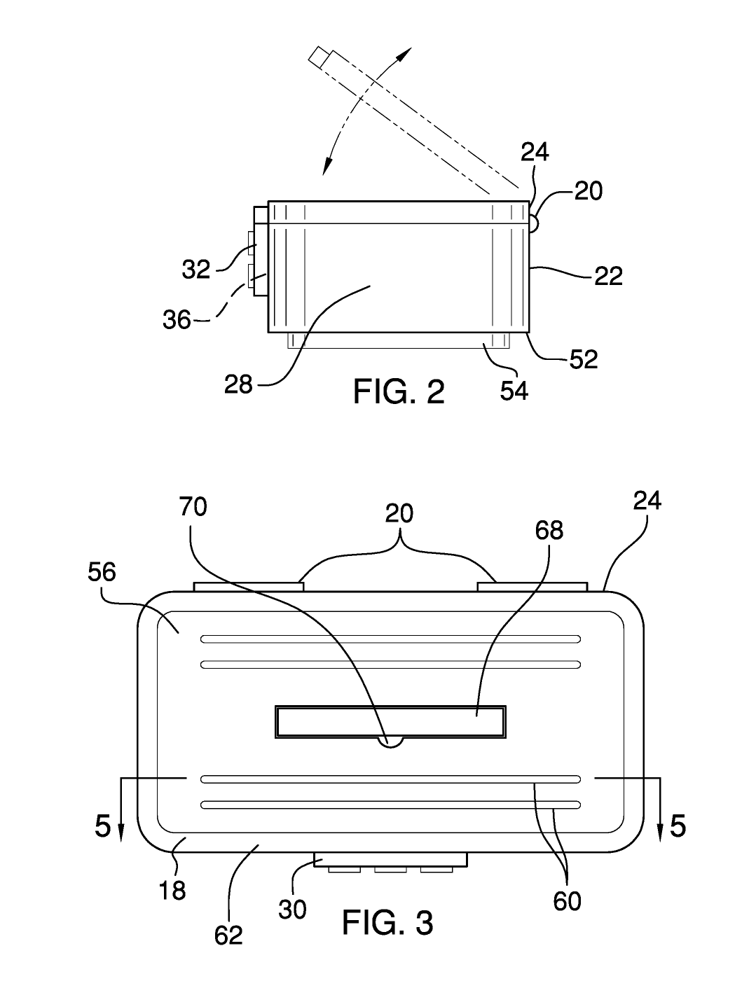

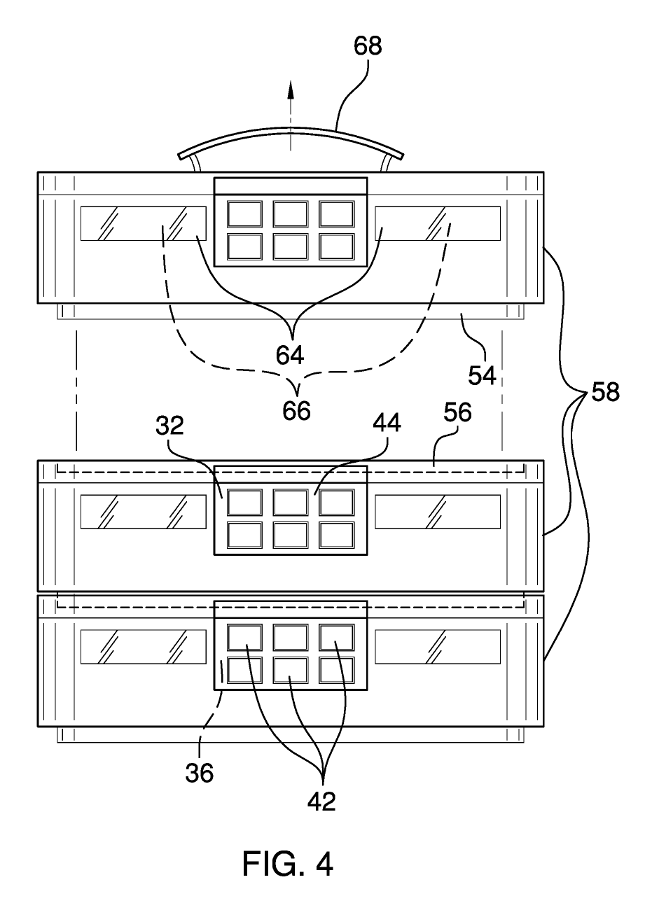

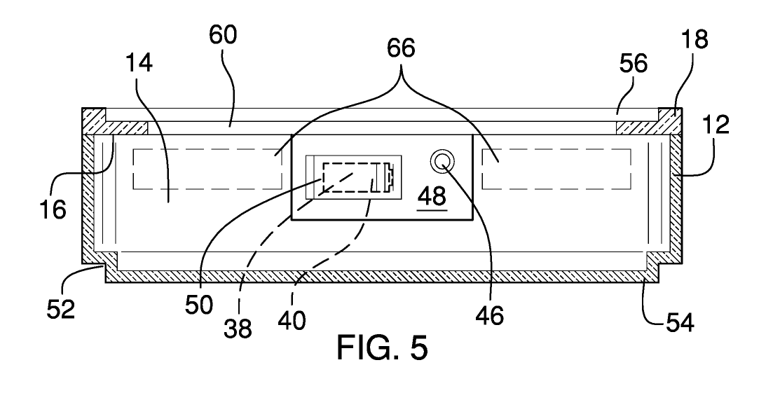

With reference now to the drawings, and in particular to FIGS. 1 through 5 thereof, a new container embodying the principles and concepts of an embodiment of the disclosure and generally designated by the reference numeral 10 will be described.

As best illustrated in FIGS. 1 through 5, the secured container 10 generally comprises a shell 12 that defines an internal space 14. The shell 12 has a top 16 that is open. The top 16 is configured to position items, such as food, into the internal space 14. In one embodiment, the shell 12 is substantially rectangularly box shape. In another embodiment, the shell 12 comprises high-impact plastic.

A lid 18 is hingedly coupled to the shell 12. The lid 18 is complementary to the top 16. The lid 18 is lockably couplable to the shell 12 to secure the items that are positioned in the internal space 14. In one embodiment, each of a pair of hinges 20 is coupled to and extends between a back 22 of the shell 12 and a rear edge 24 of the lid 18. The hinges 20 are positioned to pivot to selectively position the lid 18 in an open configuration and a closed configuration.

A locking assembly 26 is coupled to a front 34 of the shell 12. The locking assembly 26 is selectively couplable to the lid 18. The locking assembly 26 is positioned to selectively couple to the lid 18 to secure the items that are positioned in the internal space 14. In one embodiment, the locking assembly 26 is positioned substantially equally distant from opposing sides of 28 the shell 12. In another embodiment, the locking assembly 26 comprises a keypad lock 30. The keypad lock 30 comprises a housing 32. The housing 32 is positioned in the front 34 of the shell 12 and defines an interior space 36. A power module 38 is coupled to the housing 32 and is positioned in the interior space 36. In another embodiment, the power module 38 comprises at least one battery 40. A set of six buttons 42 is coupled to a forward face 44 of the housing 32. The buttons 42 are operationally coupled to the power module 38. The buttons 42 are configured to enter a code to selectively and reversibly couple the locking assembly 26 to the lid 18 to secure the items that are positioned in the internal space 14.

A reset button 46 is positioned on a rearward face 48 of the housing 32. The reset button 46 is positioned to be accessed from the internal space 14. The reset button 46 is operationally coupled to the buttons 42. The reset button 46 is configured to delete an old code so that the buttons 42 are configured to enter a new code.

A plate 50 is positioned in the rearward face 48 adjacent to the power module 38. The plate 50 is reversibly couplable to the housing 32. The plate 50 is selectively removable to access the power module 38.

An inset 52 is positioned around a bottom perimeter 72 of the shell 12 to define an extension 54. A recess 56 is positioned in the lid 18. The recess 56 is substantially complementary to the extension 54. The recess 56 is positioned in the lid 18 and the extension 54 is positioned on the shell 12 such that a plurality of shells 58, with the lids 18 in the closed configuration, are stackable.

A plurality of slits 60 is positioned through the lid 18. The slits 60 are configured to vent the internal space 14. In one embodiment, the slits 60 are selectively closable. In another embodiment, the plurality of slits 60 comprises four slits 60 that are positioned two each proximate to the rear edge 24 and a forward edge 62 of the lid 18.

A pair of panels 64 is coupled to the front 34 of the shell 12 to define a pair of slots 66. The panels 64 are substantially transparent. The slots 66 are configured to insert labels, such as a label that has a name of a user and a label to date the items in the internal space 14. In one embodiment, the panels 64 are substantially rectangularly shaped. In another embodiment, the panels 64 are positioned to bracket the locking assembly 26.

A handle 68 is coupled to and selectively extensible from the lid 18. The handle 68 is configured to be grasped in a hand of the user to lift the shell 12 and the lid 18. A cutout 70 is positioned in the lid 18 adjacent to the handle 68. The cutout 70 is configured to insert an end of a finger to extend the handle 68 from the lid 18.

In use, the top 16 is configured to position the items, such as the food, into the internal space 14. The hinges 20 are positioned to selectively pivot to position the lid 18 in the open configuration and the closed configuration. The buttons 42 positioned on the housing 32 are configured to enter the code to selectively and reversibly couple the locking assembly 26 to the lid 18 to secure the items that are positioned in the internal space 14. The reset button 46 positioned on the housing 32 is configured to delete the old code so that the buttons 42 are configured to enter the new code. The slots 66 positioned on the shell 12 are configured to insert the labels, such as the label has the name of the user and the label to date the items that are in the internal space 14. The slits 60 positioned in the lid 18 are configured to vent the internal space 14. The cutout 70 positioned in the lid 18 is configured to insert the end of the finger to extend the handle 68 from the lid 18. The handle 68 positioned on the lid 18 is configured to be grasped in the hand of the user to lift the shell 12 and the lid 18. The recess 56 positioned in the lid 18 and the extension 54 positioned on the shell 12 are positioned such that the plurality of shells 58, with the lids 18 in the closed configuration, are stackable.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A detachable vehicular lighting device comprising:
a housing, said housing comprising:
a bottom, said bottom being substantially rectangular and having an outer perimeter, said bottom having an opening defining an inner perimeter,
an outer casing, said outer casing being coupled to said outer perimeter and extending transversely from said bottom,
an inner casing, said inner casing being coupled to said inner perimeter, said inner casing coextending with said outer casing, said inner casing defining a cavity positioned in said bottom of said housing, and
said bottom, said outer casing and said inner casing defining an internal space;
a power module, said power module being coupled to said housing and positioned in said internal space;
a plurality of lights, said lights being coupled to said housing and positioned in said internal space, said lights being operationally coupled to said power module;
a switch, said switch being operationally coupled to said power module and said plurality of lights, said switch being coupled to and positioned through said housing and being positioned in said cavity along said inner perimeter of said housing wherein said switch is accessible through said opening;
a fastener; said fastener being coupled to said bottom, said fastener being configured to couple said housing to the exterior surface of a vehicle, said fastener being a magnet, said magnet being coupled to said bottom wherein said magnet is configured for removably coupling said housing to a vehicle to facilitate access to said cavity through said opening while said housing is disengaged from the vehicle and is further configured for inhibiting contact with said switch while said housing is coupled to the vehicle.

2. The device of claim 1, further including said bottom having corners, said corners being rounded.

3. The device of claim 1, further including said bottom having a pair of elongated sides.

4. The device of claim 1, further including said outer casing being rounded, such that said housing is domed.

5. The device of claim 1, further including said housing being rigid.

6. The device of claim 1, further including said housing comprising plastic.

7. The device of claim 1, further including said housing comprising hardened plastic.

8. The device of claim 1, further including said power module comprising at least one battery.

9. The device of claim 1, further including said plurality of lights comprising light emitting diodes.

10. The device of claim 1, further comprising:
said plurality of lights comprising white light emitting diodes;
said outer casing being absorbent of light except red light and blue light; and
wherein said housing appears purple.

11. The device of claim 1, further comprising
said plurality of lights comprising red light emitting diodes and blue light emitting diodes;
said outer casing being transparent; and
wherein said housing appears purple.

12. The device of claim 1, further including a controller, said controller being coupled to said housing and positioned in said internal space, said controller being operationally coupled to said switch and said plurality of lights, such that said controller is configured to induce a flashing effect to said plurality of lights.

13. The device of claim 1, further including a port, said port being coupled to and positioned in said housing, such that said port is configured to be accessed through said cavity for recharging said power module.

14. The device of claim 13, further including said port comprising a universal serial bus port.

15. The device of claim 1, further including said fastener comprising a gasket, said gasket being flexible, said gasket being coupled to an outer edge of said magnet, such that said magnet is configured for magnetic coupling to the surface of a vehicle and wherein said gasket is compressed between said housing and the vehicle and sealing said housing to said vehicle.

16. The device of claim 15, further including said magnet comprising a strip magnet extending between said inner perimeter and said outer perimeter.

17. A detachable vehicular lighting device comprising:
a housing, said housing comprising:
a bottom, said bottom being substantially rectangular and having an outer perimeter, said bottom having an opening defining an inner perimeter, said bottom having corners, said corners being rounded, said bottom having a pair of elongated sides,
an outer casing, said outer casing being coupled to said outer perimeter and extending transversely from said bottom, said outer casing being rounded, such that said housing is domed,
an inner casing, said inner casing being coupled to said inner perimeter, said inner casing coextending with said outer casing, said inner casing defining a cavity positioned in said bottom of said housing, and
said bottom, said outer casing and said inner casing defining an internal space;
said housing being rigid, said housing comprising plastic, said housing comprising hardened plastic;
a power module, said power module being coupled to said housing and positioned in said internal space, said power module comprising at least one battery;
a plurality of lights, said lights being coupled to said housing and positioned in said internal space, said lights being operationally coupled to said power module, said plurality of lights comprising light emitting diodes;
a switch, said switch being operationally coupled to said power module and said plurality of lights, said switch being coupled to and positioned through said housing and being positioned in said cavity along said inner perimeter of said housing wherein said switch is accessible through said opening;
a controller, said controller being coupled to said housing and positioned in said internal space, said controller being operationally coupled to said switch and said plurality of lights, such that said controller is configured to induce a flashing effect to said plurality of lights;
a port, said port being coupled to and positioned in said housing, such that said port is configured to be accessed through said cavity for recharging said power module, said port comprising a universal serial bus port;
a fastener; said fastener being coupled to said bottom, said fastener being configured to couple said housing to the exterior surface of a vehicle, said fastener comprising:
a magnet, said magnet being coupled to said bottom wherein said magnet is configured for removably coupling said housing to a vehicle to facilitate access to said cavity through said opening while said housing is disengaged from the vehicle and is further configured for inhibiting contact with said switch while said housing is coupled to the vehicle, said magnet comprising a strip magnet extending between said inner perimeter and said outer perimeter, and
a gasket, said gasket being flexible, said gasket being coupled to an outer edge of said magnet, such that said magnet is configured for magnetic coupling to the surface of a vehicle and wherein said gasket is compressed between said housing and the vehicle and sealing said housing to said vehicle;
wherein said cavity is configured to be accessed by the user to engage said switch to turn on said plurality of lights, and said fastener coupled to said bottom is configured for coupling said housing to the surface of a vehicle, and wherein additional said detachable vehicular lighting devices are configurable to be attached to additional vehicles, such that multiple vehicles are identifiable as a group or caravan when traveling.

18. The device of claim 17, further comprising:
said plurality of lights comprising white light emitting diodes;
said outer casing being absorbent of light except red light and blue light; and
wherein said housing appears purple.

19. The device of claim 17, further comprising
said plurality of lights comprising red light emitting diodes and blue light emitting diodes;
said outer casing being transparent; and
wherein said housing appears purple.
